(19) United States
(12) Patent Application Publication
(10) Pub. No.: US 2013/0168623 A1
(43) Pub. Date: Jul. 4, 2013

(54) DEVICE COMPRISING A CYLINDER, SUCH AS A SPREADER

(71) Applicant: Adrianus Cornelis Maria Jacobs, Bosschenhoofd (NL)

(72) Inventor: Adrianus Cornelis Maria Jacobs, Bosschenhoofd (NL)

(73) Assignee: N.V. Holmatro, Raamsdonkaveer (NL)

(21) Appl. No.: 13/702,061

(22) PCT Filed: Jun. 1, 2011
(86) PCT No.: PCT/NL2011/050391

§ 371 Date: Feb. 18, 2013

(30) Foreign Application Priority Data
Jun. 4, 2010 (NL) 2004821

(51) Int. Cl. B66F 11/00

(52) U.S. Cl. CPC B66F 11/00
USPC 254/93 R

(57) ABSTRACT

The present invention relates to a device such as a spreader. This device comprises a cylinder housing, a plunger hydraulically displaceable in the cylinder housing and having thereon a piston rod extending outside the cylinder housing in order to form a cylinder with the cylinder housing, an extension forming a mechanically extendable unit with at least one of the cylinder and the piston rod, and a locking which acts in selectively actuable manner on the unit for mechanically setting a loadable presetting of a length of the device desired for use of the cylinder.

The present invention relates to a device with a hydraulic cylinder, such as a spreader, which is used by diverse rescue services worldwide.

Such spreaders are used for instance to free victims trapped in a vehicle involved in an accident or in other similar situations by pressing aside or lifting heavy structural parts. This displacement of loads has to be performed quickly and safely and hydraulically operating cylinders with sufficient force are necessary for this purpose. These hydraulic cylinders are characterized by a plunger with piston rod which, using a control (for instance an integrated control), can be arrested in continuously variable manner in any desired position. The load displaced in this way is secured against return movement by means of built-in hydraulic non-return valves.

The known devices do however have a drawback. The speed of the displacement of the plunger in the cylinder is determined by the oil displacement of the hydraulic pump. For safety reasons and for ergonomic reasons the oil displacement of this type of pump is small, with the result that the speed of the plunger is low. It is however desirable to be able to employ the device for rapid operation. A correct insertion length of the device (and so the length of the combination of the cylinder and the plunger with the piston rod thereon) must be realized quickly for this purpose so that the device can be placed quickly between parts to be pressed apart, and as little time as possible is lost in doing so. In the known devices much time is lost in extending the plunger in unloaded manner in order to obtain the desired insertion length before the device is placed between these parts and makes contact with these parts.

It is known to have different cylinders in multiple lengths available. This does however require extra storage space and load capacity of the vehicle with which the tools are transported.

It is also known to make use of telescopic cylinders or of cylinders with plungers extending to two sides. The drawback of telescopically extending plungers is the small end force of the final plunger compared to the force of the first, largest plunger. Actuation of a telescopic cylinder further requires a large amount of oil, whereby the associated pump must comprise a large oil reservoir.

With cylinders having two extendable plungers per cylinder housing it is also the case that the speed of insertion depends on the oil displacement of the pump. In many cases the required displacement of the hydraulic plunger under load (pressing against the parts to be pressed apart in for instance a crashed car) is small, but a stroke (extending length) to be brought about hydraulically is still necessary to bridge the difference between the cylinder's own closed length and the space between the parts to be pressed apart before force can be applied to the parts to be pressed apart.

The present invention has for its object to obviate the drawbacks of the known art, for which purpose a device, such as in particular a spreader, has all the features as defined in the single independent claim.

A device is thus provided according to the present invention in which a combination is realized of a powerful hydraulic mechanism with the possibility of a rapid and simple mechanical presetting of a length of the device which approximates a desired length for the purpose of rapidly exerting hydraulic force on for instance parts to be pressed apart. This is achieved on the basis of the extension with which such a presetting is quickly possible. It is thus possible at the desired insertion location to first extend the mechanically adjustable part to approximately the desired length of the device and to subsequently extend the hydraulic plunger. Using this construction operation can thus take place much more quickly because the plunger of the hydraulic cylinder need only make a minimal unloaded stroke before the plunger comes into contact with the parts to be pressed apart. In addition, much less oil displacement is necessary. The mechanical setting of the extension can take place according to the invention in a few seconds. Actuation of the locking at a length reached by the device preferably takes place automatically, for instance following release of a control member, and the hydraulic plunger can then be placed into contact with the parts to be pressed apart. This results in a kind of mechanical quick adjustment for spanning the length difference, after which the hydraulic plunger produces the force in order to displace the load.

In a preferred embodiment the device according to the invention has the feature that the extension is telescopically slidable in and out relative to the piston rod in manual and mechanical manner.

A device according to the invention preferably has the feature however that the extension is at least axially displaceable relative to and securable to the cylinder housing. The extension can thus comprise a kind of bush-like or cylindrical housing of the cylinder, which can be useful in forming a protection for the cylinder without resulting—as in the above stated embodiment—in a potential weakening of the piston rod, although neither option is precluded from the scope of protection of the present invention.

It can be favourable in such an embodiment for a guide to be arranged on the cylinder housing for linear axial movement of the extension relative to the cylinder housing. Such a guide can have the advantage that parts and components on the cylinder, such as hydraulic connections, and (on) the extension do not damage each when the device is shortened and lengthened.

In an additional or alternative embodiment of the invention the device has the additional or alternative feature of a releasable and radially adjustable handgrip which can be secured to the device in at least two radial positions relative to the cylinder. Such handgrip is useful in enabling easy carrying of the device, and the radial adjustability ensures that the handgrip need never be in the way when the device is placed at a location of use and the cylinder is set into hydraulic operation.

In such an embodiment it can be advantageous for the device to further comprise a coupling for selective and releasable securing of the handgrip in one selected position of the least two positions. More positions are likewise possible within the scope of the present invention. The well-defined positions allow a very practical adjustment or rotation of the handgrip to a position which causes the least possible obstruction during use, so that obstruction by the handgrip can also be avoided with certainty when the cylinder is in operation. Such obstruction could be caused by a position of the handgrip, wherein the handgrip comes to lie against a fixed element in the vicinity, which could counteract the force to be produced by the cylinder.

In a further embodiment a device according to the invention with a handgrip which can be rotated (out of the way) and a coupling can have the feature that the coupling comprises a ring round the cylinder housing which is associated with the guide and has at least two outward oriented engaging points corresponding to the at least two positions. This is a very elegant and simple embodiment. The guide can play an important part here if it is also provided, since in some embodiments the ring must be able to move with the handgrip along the length of the cylinder but must remain fixed in radial direction in order to provide a locking for the radially rotatable handgrip. This can be realized if the ring is then connected to the guide. It can also be favourable here for the device to have the feature that the engaging points comprise recesses for receiving a ball therein in a coupled position, and wherein the coupling comprises a control associated with the handgrip for pressing the ball selectively into an associated recess and another recess of complementary shape relative to the ball in or on the handgrip in order to selectively block or release rotation of the handgrip relative to the ring.

Additionally or alternatively a device according to the invention with an extension adjustable along or at least relative to the cylinder can have the feature that the locking comprises: at least two stops on the outer side of the cylinder housing at a distance from each other in the axial direction of the cylinder; and at least one blocking block on the extension which is radially movable so as to lie, in a position protruding radially from the extension, against a maximum of one of the stops, and in a radially retracted position is clear of the stops. In such an embodiment the device can be easily preset in discrete steps so as to have at least approximately a length desired in order to apply force with the hydraulic cylinder, for instance against parts to be pressed apart, for instance of a crashed vehicle. The stops can here comprise cylindrical thickened portions on the outer side of the cylinder, and these can comprise at least a sloping side in order to simplify mechanical (manual) lengthening of the device. The blocking block can comprise at least two segments which can be pressed by pressing means, in particular a spring, to a starting position. The locking can comprise a release. The release can be a controllable counter-mechanism which in an actuated state forces the blocking block to an end position. With such a starting position and an end position a thus embodied locking can be operated very easily, while a properly locked situation in which the device is suitable for rapid hydraulic loading is realized with certainty.

The end position is then preferably the protruding position and the starting position is the retracted position. This is perhaps contrary to expectation but produces an excellent locking.

The counter-mechanism can comprise: a ring with a polygonal inner peripheral form; and at least two balls which are situated along the inner periphery of the ring at a distance from each other and which lie against the segments. The stated starting and end positions are thus well-defined and use is simple: the locking can be operated by rotating the ring.

The stops can have at least one sloping side. Lengthening then proceeds easily, wherein the sloping sides assist in pressing aside the blocking block.

An embodiment can then be further provided wherein the extension comprises a bush, into which or from which the cylinder is slidable in a deactivated state of the locking. The extension can thus form a protection for the cylinder.

In yet another embodiment a device according to the invention can be such that the cylinder is double-acting. Force can be applied here when the cylinder is retracted as well as when it is extended. The device can therefore also be used for pulling instead of just for pushing.

In an embodiment with a guide the device can be embodied such that the guide is formed by a hydraulic conduit arranged along the cylinder housing. This conduit then serves for feed and discharge of hydraulic fluid, but can also serve as guide for the handgrip and the ring of a coupling in order to enable an angular adjustment of the handgrip.

The invention will be further elucidated hereinbelow on the basis of an exemplary embodiment shown in the drawing, which serves only by way of illustration and may by no means be seen as limitative of the invention, since the scope of protection thereof is defined in the appended claims, in particular only the single independent claim. The same or similar parts, components and elements are designated in the drawing with the same reference numerals, and in the drawing:

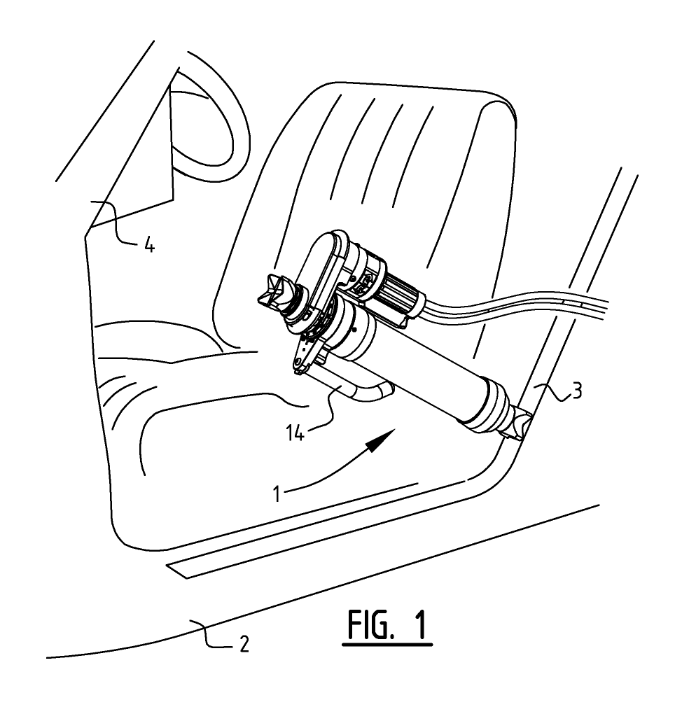

FIG. 1 is a perspective view of a device according to the present invention in use;

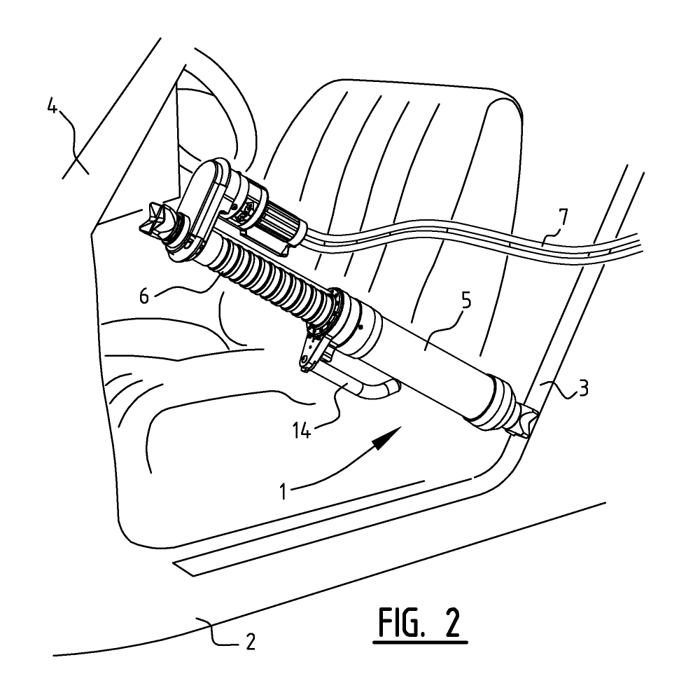

FIG. 2 is a perspective view of the device of FIG. 1 in an extended position;

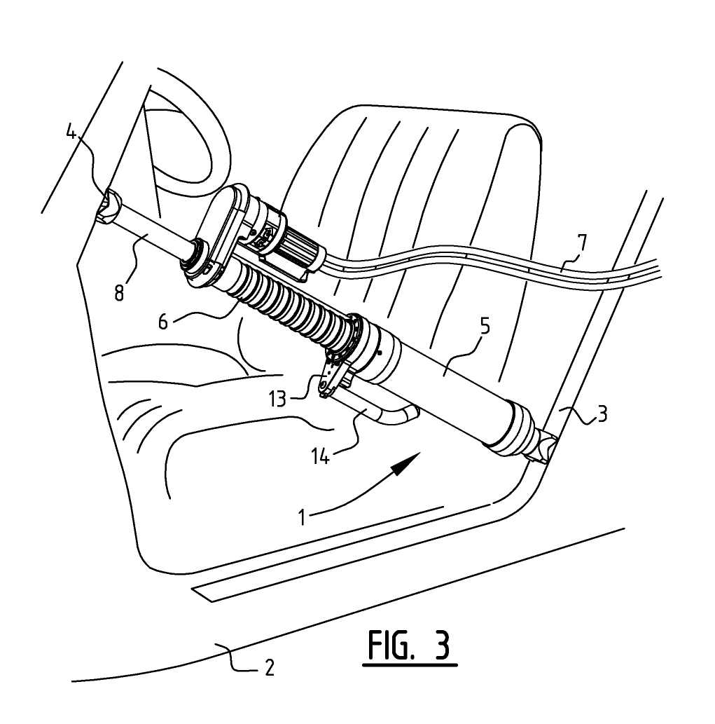

FIG. 3 is a perspective view of the device of FIG. 1 in a hydraulically actuated state;

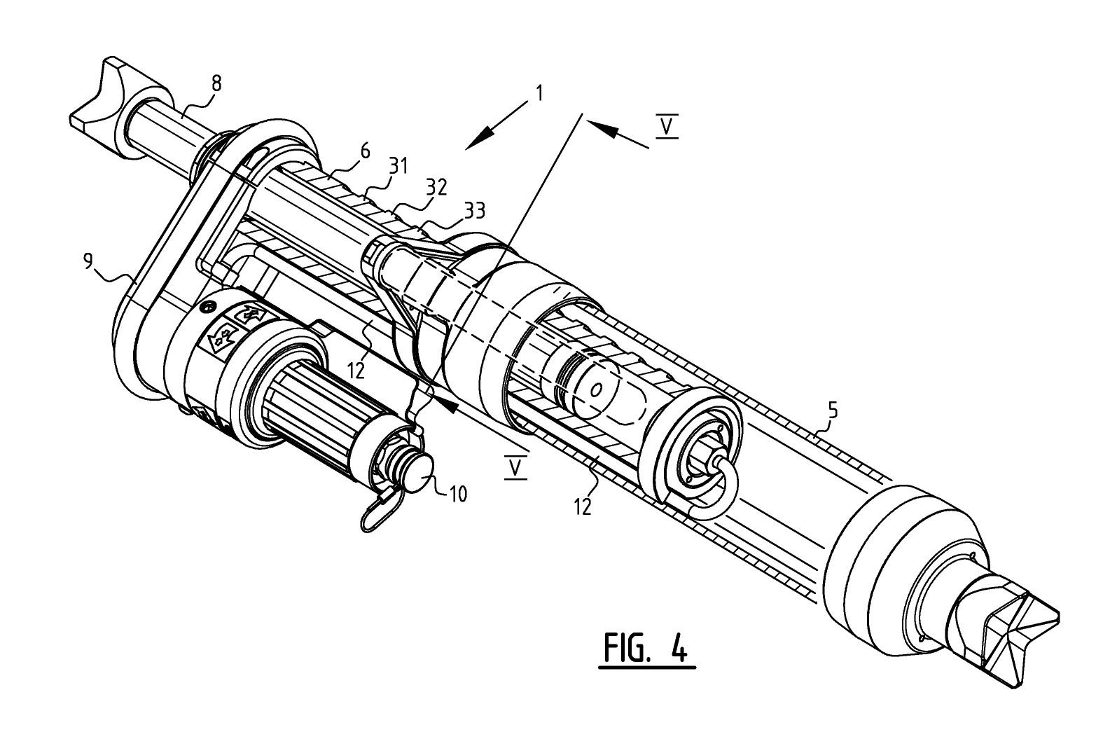

FIG. 4 is a perspective and partially cut-away view of the device of the foregoing figures;

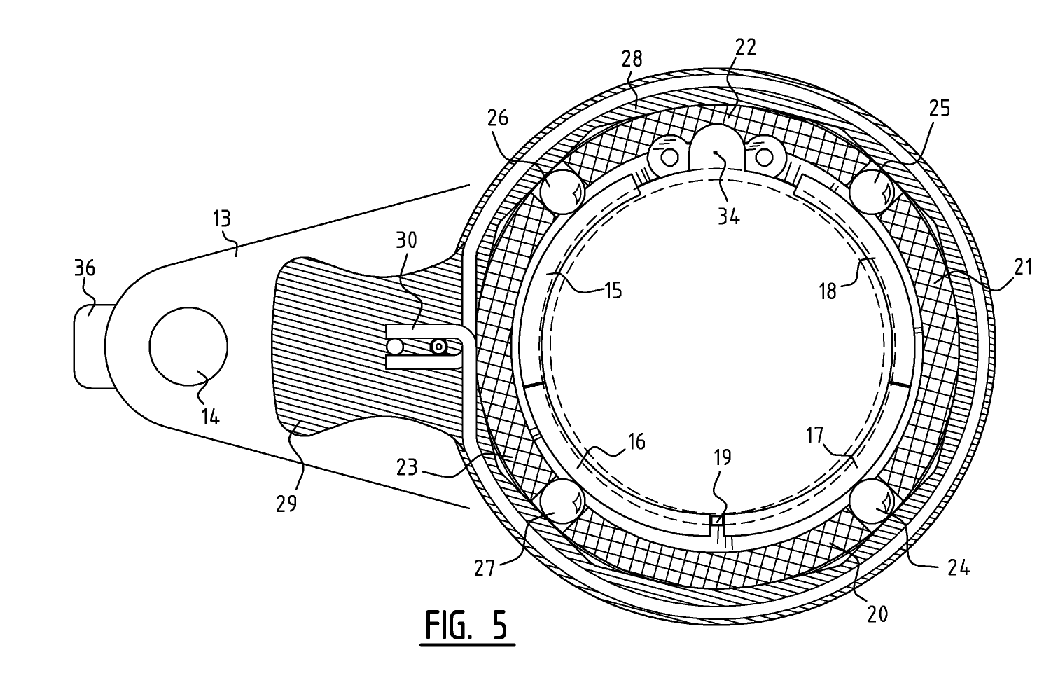

FIG. 5 is a cross-sectional view along the line V-V in FIG. 4;

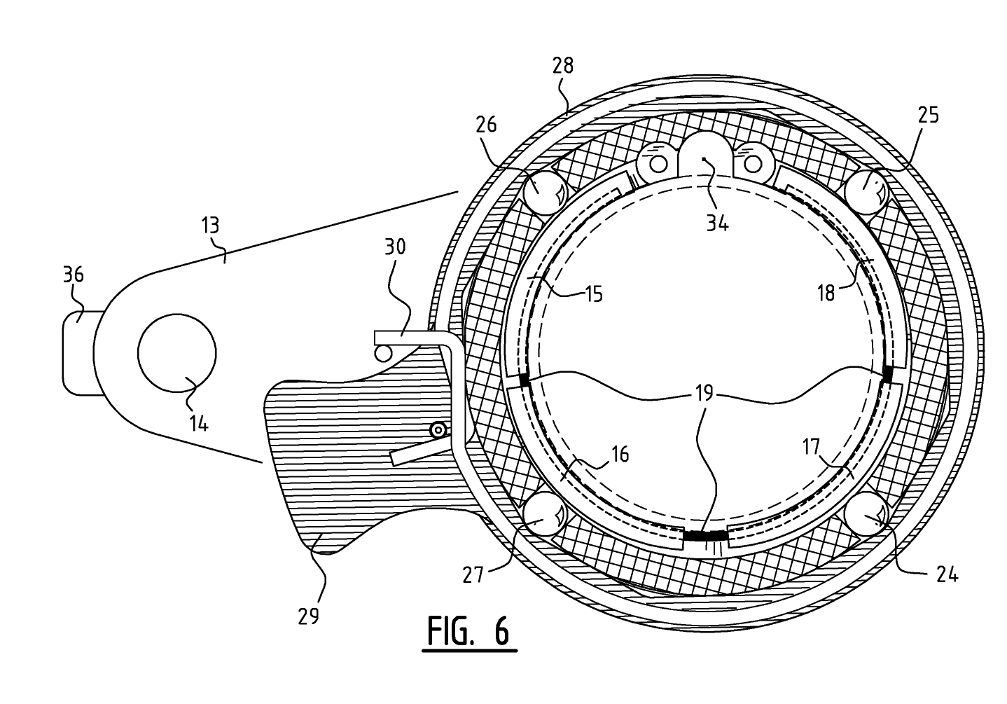

FIG. 6 is a cross-sectional view corresponding to FIG. 5 with a released locking;

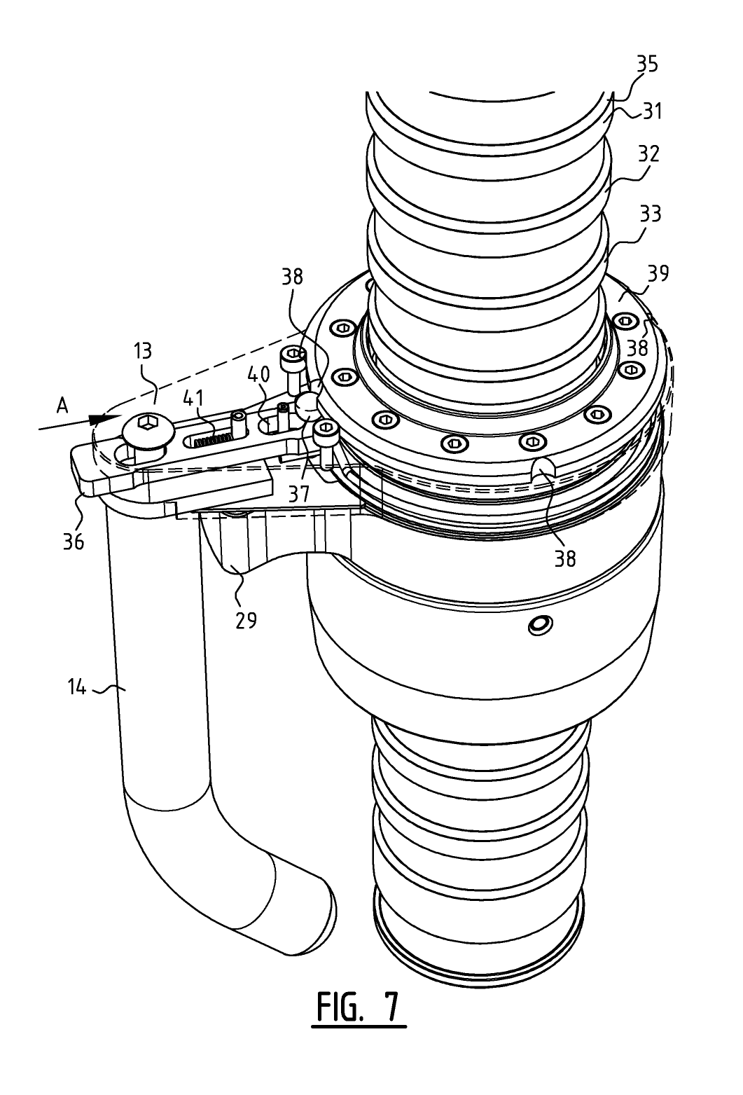

FIG. 7 is a perspective and partially cut-away view of a handgrip with a coupling for securing thereof; and

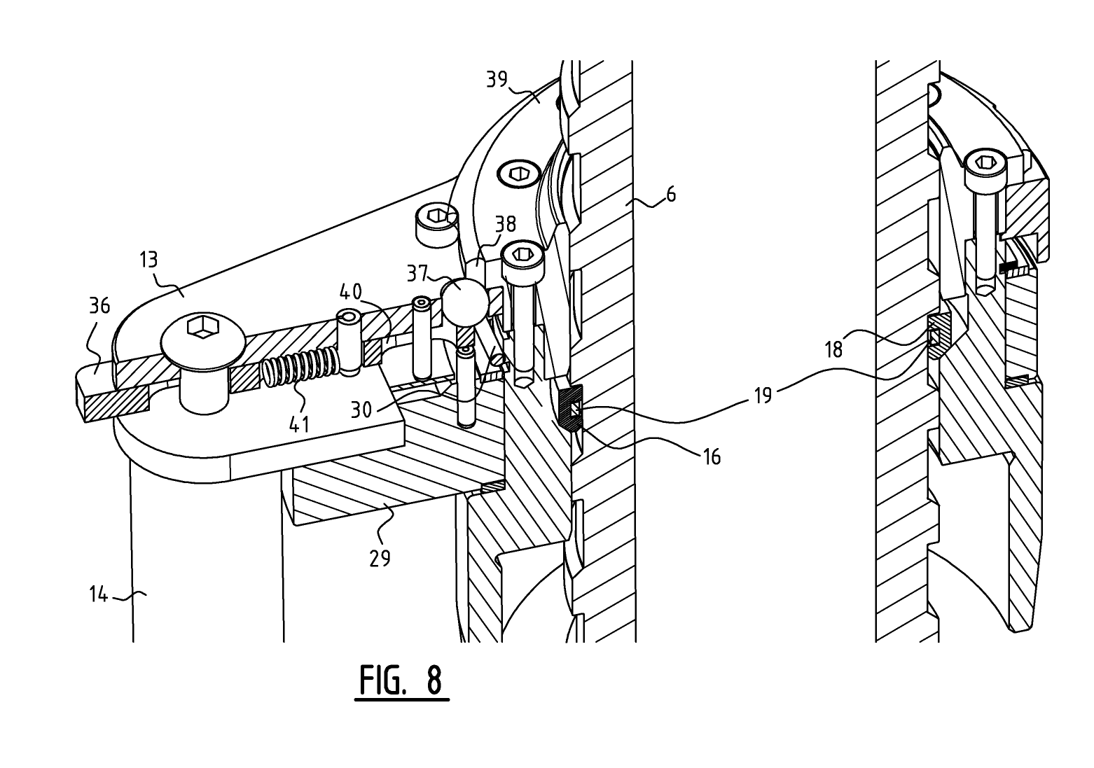

FIG. 8 shows in more detail a cut-away view of the combination of the handgrip and the blocking thereof, as well as the locking.

FIGS. 1, 2 and 3 show a device 1 according to the present invention in various operational states thereof. Device 1 is used in the shown exemplary embodiment to force open a door opening between pillars 3, 4 of a crashed car 2 in order to free a passenger (not shown) from car 2. In the situation shown in FIG. 1 the device 1 is placed against a first pillar 3. In the prior art it was then necessary to immediately increase hydraulic pressure in the cylinder situated in device 1, a further description of which follows below.

According to the present invention, and as shown in FIG. 2, use is however made of an extension 5 with which device 1 can be lengthened mechanically and manually in order to span the distance between pillars 3, 4 of the car more quickly than with hydraulic pressure. Upon reaching a desired length of device 1 a locking to be described below is activated in order to enable loadable blocking of extension 5 and cylinder 6. Only then is the hydraulic pressure in the cylinder increased via hydraulic conduits 7 in order to slide a plunger with a piston rod 8 thereon out of cylinder 6 in order to span the final part of the distance between pillars 3, 4, as shown in FIG. 3.

The device 1 is shown in more detail in FIG. 4. Cylinder 6 can be slid manually into and out of extension 5, this extension being formed here as a tube or bush into which cylinder 6 fits. When a desired length is reached, the relative positioning of extension 5 and cylinder 6 is secured using a locking to be further described below, so that the thus locked assembly of extension 5 and cylinder 6 can be loaded when piston rod 8 is extended under the influence of hydraulic pressure.

Arranged on the part of cylinder 6 protruding from extension 5 is a connecting part 9 to which the hydraulic conduits 7 (not shown here) can be connected at connector 10. Further arranged on connecting part 9 are control buttons 11 for activating and deactivating cylinder 6, and more particularly for controlling the movement of piston rod 8 in and out of cylinder 6.

In the embodiment shown here cylinder 6 takes a double-acting form. A hydraulic conduit 12 runs for this purpose from connecting part 9 to the outer end of cylinder 6 located in the interior of extension 5. For reasons to be elucidated below this hydraulic conduit 12 is a form-retaining tube, this being related to the dual function of this conduit 12 as guide for a linear movement of cylinder 6 relative to extension 5. Arranged on the side of connecting part 9 is a connection (not shown) to the interior of cylinder 6 so that cylinder 6 is actually double-acting.

FIG. 5 shows a locking in the cross-section along the line V-V in FIG. 4. The locking is situated at the outer end of extension 5 where cylinder 6 can be moved manually in and out of extension 5. The locking provides for a fixation of the positioning of extension 5 and cylinder 6 relative to each other. FIG. 5 shows a locked state of the locking and FIG. 6 a released state of the locking. This locking comprises four separate segments 15, 16, 17 and 18, on which a spring 19 acts so as to generate a bias for pressing the segments 15-18 outward. Arranged outside the periphery defined by segments 15-18 are filler pieces 20-23 having in each case a ball 24-27 between them, with a ring 28 of octagonal inner peripheral form outside filler pieces 20-23 and balls 24-27. Further arranged on ring 28 is a handle 29 for enabling rotation of ring 28 with the polygonal inner peripheral form through an angular distance from the position shown in FIG. 5 to the position shown in FIG. 6. A spring 30 arranged along ring 28 then urges the ring back to the position of handle 29 shown in FIG. 5, i.e. under or in any case close to a connecting plate 13 which runs to a handgrip 14. When handle 29 is rotated from the position shown in FIG. 5 to the position shown in FIG. 6, space is created for the balls 24-27 to displace outward into the angles of the polygonal inner peripheral form of ring 28. A counter-mechanism is thus deactivated which in fact presses inward and holds the segments 15-18 in the position shown in FIG. 5. When balls 24-27 displace outward into the angles of the polygonal inner peripheral form of ring 28, segments 15-18 are also displaced outward by means of spring 19 so that a larger inner space is left clear as defined by segments 15-18, and the locking is therefore then deactivated (in the position of handle 29 shown in FIG. 6). Arranged on the outer surface of cylinder 6 are thickened portions 31, 32, 33 which form the stops to be engaged by segments 15-18 in the narrower parts of the outer surface of cylinder 6 between thickened portions 31, 32, 33 with handle 29 in the position thereof shown in FIG. 5. Segments 15-18 therefore drop into the narrower spaces between thickened portions 31-33 in the position of handle 29 shown in FIG. 5, while the segments are retracted from these narrower parts between thickened portions 31-33 in the situation shown in FIG. 6, in which handle 29 is rotated relative to the position shown in FIG. 5.

A user can thus rotate handle 29 through a short angular distance, whereby segments 15-18 are retracted from the narrower parts between thickened portions 31-33 on the outer surface of cylinder 6. The locking is then inoperative and cylinder 6 can slide freely in and out of extension 5 in order to realize a rapid presetting of the combined length of extension 5 and cylinder 6 without making use of hydraulics. When a desired combined length has been reached, the user releases handle 29 which, through the action of spring 30, is then swivelled back again to connecting plate 13 to allow the segments to be pressed inward with balls 24-27.

A space 31 is further left clear for passage of the hydraulic, form-retaining conduit 12, which therefore also serves as guide for the linear sliding of cylinder 6 in and out of extension 5.

In the perspective view of FIG. 7 this hydraulic, form-retaining conduit 12 runs on the rear side and is therefore hidden from view.

FIG. 7 further shows the thickened portions 31-33 which each comprise on the upper side thereof a radial edge 35 on which the segments of FIGS. 5 and 6 can rest with certainty in an actuated state of the thus formed locking.

FIG. 7 further shows handgrip 14 on connecting plate 13. A control member 36 is arranged in connecting plate 13. When this is moved in the direction of arrow A, a ball 37 drops out of a recess 38, of which at least two, and in the embodiment shown here even four are arranged in the outer periphery of a circular ring 39 arranged round cylinder 6, and remains stationary relative to the cylinder when handgrip 14 on connecting plate 13 can be swivelled around the cylinder. This can be useful because available space for handgrip 14 may be lacking in a situation of use, and the handgrip can then be swivelled aside in simple manner. When control member 36 is pressed in the direction of arrow A, ball 37 drops into a slot 40, and connecting plate 13 with handgrip 14 thereon can be rotated round cylinder 6. Member 36 can here be released by the operator and, due to the action of a spring 41, is then pressed outward again in the direction opposite to that of arrow A. Ball 37 presses here against the outer periphery of ring 39 until a rotation as far as another recess 38 has been realized. Ball 37 then drops into the encountered recess 38 and connecting plate 13 with handgrip 14 will then be coupled again.

FIG. 8 shows a partially cut-away view showing the mutual relation between many of the above described parts and components. FIG. 8 shows only the segments forming part of the locking, but not the balls 24-27 or filler elements 20-23. Through operation of handle 29 the movement of cylinder 6 in and out of extension 5 is released, and through operation of member 36 the handgrip 14 can be swivelled round the periphery of the cylinder for positioning at a favourable location in order to prevent the handgrip 14 ever being able to form an obstruction.

After examination of the foregoing and comprehensive figure description many additional and alternative embodiments will occur to the skilled person, which must however all be deemed as lying within the scope of protection of the present invention, unless such embodiments depart in letter or in spirit from the scope of protection defined in the claims.

1. A spreader device, comprising:
a cylinder housing;
a plunger hydraulically displaceable in the cylinder housing and having thereon a piston rod extending outside the cylinder housing to form a cylinder with the cylinder housing; and
a releasable and radially adjustable handgrip securable to the device in at least two radial positions relative to the cylinder.

2. The device of claim 1, further comprising:
an extension forming a mechanically extendable unit with at least one of the cylinder and the piston rod; and
a locking selectively actuable on the unit for mechanically setting a loadable presetting of a length of the device for the cylinder.

3. The device of claim 2, wherein the extension is telescopically slidable in and out relative to the piston rod in a manual and mechanical manner.

4. The device of claim 2, wherein the extension is at least axially displaceable relative to and lockable on the cylinder housing.

5. The device of claim 4, wherein a guide is arranged on the cylinder housing for linear axial movement of the extension relative to the cylinder housing.

6. The device of claim 1, further comprising:
a coupling for selective and releasable securing of the handgrip in a selected position of the at least two radial positions relative to the cylinder.

7. The device of claim 6, wherein the coupling comprises a ring arranged around the cylinder housing which is associated with the guide and has at least two outward oriented engaging points corresponding to the at least two positions.

8. The device of claim 7, wherein the engaging points comprise recesses for receiving a ball therein in a coupled position, and wherein the coupling comprises a control associated with the handgrip for pressing the ball selectively into an associated recess and another recess of complementary shape relative to the ball in or on the handgrip in order to selectively block or release rotation of the handgrip relative to the ring.

9. The device of claim 2, wherein the locking comprises:
at least two stops on the outer side of the cylinder housing at a distance from each other in the axial direction of the cylinder; and
at least one blocking block on the extension which is radially movable so as to lie, in a position protruding radially from the extension, against a maximum of one of the stops, and in a radially retracted position is clear of the stops.

10. The device of claim 9, wherein the stops comprise cylindrical thickened portions on an outer side of the cylinder.

11. The device of claim 9, wherein the blocking block comprises at least two segments which are pressed by a spring to a starting position.

12. The device of claim 2, wherein the locking comprises a release.

13. The device of claim 12, wherein the release is a controllable counter-mechanism which in an actuated state forces the blocking block to an end position.

14. The device of claim 13, wherein the end position is the protruding position and the starting position is the retracted position.

15. The device of claim 13, wherein the counter-mechanism comprises:
a ring with a polygonal inner peripheral form; and
at least two balls which are situated along the inner periphery of the ring at a distance from each other and which lie against the segments.

16. The device of claim 9, wherein the stops have at least one sloping side.

17. The device of claim 2, wherein the extension comprises a bush, into which or from which the cylinder is slidable in a deactivated state of the locking.

18. The device of claim 1, wherein the cylinder is double-acting.

19. The device of claim 5, wherein the guide comprises a hydraulic conduit arranged along the cylinder housing.
